(19) United States
(12) Patent Application Publication
(10) Pub. No.: US 2007/0294914 A1
(43) Pub. Date: Dec. 27, 2007

(54) DRYING CYLINDER

(76) Inventors: Rainer Kloibhofer, Neumarkt (AT); Christoph Haase, Asperhofen (AT); Thomas Gruber-Nadlinger, Langenrohr (AT); Herbert Boden, Polten (AT); Erich Rollenitz, Polten (AT); Manfred Gloser, Polten (AT)

Correspondence Address: Todd T. Taylor;Taylor & Aust, P.C., 142 S. Main Street, P.O. Box 560, Avilla, IN, 46710, US

(21) Appl. No.: 11/769,819

(22) Filed: Jun. 28, 2007

Related U.S. Application Data
(63) Continuation of application No. PCT/EP05/56151, filed on Nov. 22, 2005.

(30) Foreign Application Priority Data
Jan. 5, 2005 (DE) 10 2005 000 782.1

(51) Int. Cl. F28F 5/02; F28D 11/02; F26B 13/00

(52) U.S. Cl. 34/624; 165/90; 492/46

(57) ABSTRACT

The invention relates to a drying cylinder which is used to dry a paper, cardboard, tissue or other web of fibrous material in a machine for the production and/or for the transformation thereof. The drying cylinder includes a support body and an external cover layer which is heated by a hot fluid. The thermal flow passing through the external cover layer is increased such that at least one cavity is provided between the support body and the external cover layer through which the fluid flows. The external cover layer is predominately so thin that the ratio formed by the thermal conductivity of the material and the thickness of the external cover layer is greater than a threshold value of 3.2 kW/m²K for steel, 30 kW/m²K for aluminum, 18 kW/m²K for bronze alloys, 3.4 kW/m²K for copper and 6.1 kW/m²K for magnesium.

### CROSS REFERENCE TO RELATED APPLICATIONS

This is a continuation of PCT application No. PCT/EP2005/056151, entitled “DRYING CYLINDER”, filed Nov. 22, 20005.

### BACKGROUND OF THE INVENTION

1. Field of the Invention

The invention relates to a drying cylinder for drying a paper, board, tissue or another fibrous web in a machine for producing and/or finishing the same, having a load bearing element and an outer cover layer which is heated by a hot fluid.

2. Description of the Related Art

Drying arrangements having drying cylinders have been known for a long time, the fibrous web wrapping around these being supported by a dryer fabric. As a result of the contact of the fibrous web with the hot circumferential surface, heating occurs and, in particular after being led away from the drying cylinder, evaporation occurs. Because of the limiting drying rate of the drying cylinders, these drying arrangements need a relatively large amount of space. The drying rate is limited substantially by the cover thickness, which is part of the thermal resistance of the drying cylinder. Due to the length of several meters and the diameter of more than one meter the drying cylinders require a relatively thick cylinder shell in order to ensure adequate stability.

What is needed in the art is a device to increase the flow of heat through the shell of a drying cylinder.

### SUMMARY OF THE INVENTION

According to the present invention, there is provided a way to increase the flow of heat through the shell and cover layer of the drying cylinder. Between the load bearing element and the outer cover layer, there is at least one cavity, through which the fluid flows. The outer cover layer is predominantly so thin that the ratio of the thermal conductivity of the material and the thickness of the outer cover layer is greater than a limiting value which is 3.2 kW/m²K for steel, 30 kW/m²K for aluminum, 18 kW/m²K for bronze alloys, 3.4 kW/m²K for copper and 6.1 kW/m²K for magnesium.

The load bearing element preferably extends axially over the entire drying cylinder and ensures adequate stability of the cylinder. This leads to a substantial relief of the load bearing function of the outer cover layer, so that the latter can be much thinner.

Essentially, the outer cover layer only has to support itself and absorb the internal pressure of the fluid in the cavity. Depending on the construction and extent of the drying cylinder and the support of the outer cover layer, the result is a minimum thickness for the outer cover layer. The upper limit of the thickness of the cover layer is given by the aforementioned limiting value for the corresponding material.

The outer cover layer can be supported on the load bearing element by way of tie rods. This can be done by way of struts, intermediate walls or the like, fixed or form-fitting connections can also be used. However, it may also be advantageous for the load bearing element to carry an inner cover layer which is connected to the outer cover layer by way of connecting elements such as webs, slats or the like, the cavity being formed between the outer and the inner cover layer.

In particular, when the fluid is steam and the pressure in the cavity lies between 1.5 and 13 bar, it should be sufficient to use an outer cover layer with a thickness of between 5 and 15 mm.

In order to improve the transfer of heat from the steam to the outer cover layer, because of the formation of condensate on the inner side of the outer cover layer, it is advantageous to design this inner side to be profiled, even grooved.

In the interest of the greatest possible flow of heat, the ratio, outside of tie rods or connecting elements, should lie above the corresponding limiting value and/or in the case of more than 60%, preferably more than 75%, of the circumferential surface of the outer cover layer, the ratio should at least on average be greater than the corresponding limiting value.

A preferred application of the heated drying cylinder, in addition to the replacement of conventional drying cylinders, results in drying arrangements for a fibrous web in which at least one water-absorbent belt runs around the drying cylinder together with the fibrous web. The fibrous web comes into contact with the drying cylinder and a further, dense belt located on the outside is cooled in the wrap region of the drying cylinder.

In drying arrangements of this type, the steam produced by the heating of the fibrous web during the contact with the heated drying cylinder passes into the water-absorbing belts surrounding the fibrous web as they wrap around the drying cylinder. In these belts, condensation and storage of the condensate occur. After wrapping around, the belts are led away from the fibrous web, cleaned and dried again.

On the belts, the dense belt wraps around the drying cylinder and in this way prevents steam from escaping. This dense belt is normally cooled, thereby intensifying the temperature gradient toward the heated drying cylinder, to predefine the direction of the evaporation from the fibrous web and to intensify the condensation of the steam.

To improve the transfer of heat, it is advantageous if the fibrous web is pressed onto the circumferential surface of the drying cylinder by a belt, preferably a dryer fabric, having a belt tension of at least 10, preferably at least 20 kN/m.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic cross section of an embodiment of a drying cylinder of the present invention;

FIG. 2 shows another embodiment of a drying cylinder of the present invention; and

FIG. 3 shows a cross section through a drying arrangement using a drying cylinder of either FIG. 1 or 2.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Referring now to the drawings, and more particularly to FIGS. 1-3, there is shown an important feature of a drying cylinder 4 according to one embodiment of the present invention as an outer cover layer 7 which is as thin as possible and which is stabilized by a load bearing element 8 of drying cylinder 4. Between load bearing element 8 and outer cover layer 7 there are a plurality of cavities 12 running axially, through which hot steam flows. This steam effects heating of outer cover layer 7 and therefore also of fibrous web 1 in contact with the latter.

In order to optimize the flow of heat through outer cover layer 7, it is as thin as possible, depending on the material used. If steel is used here, the ratio A of the thermal conductivity λ and the cover thickness s is greater than 3.2 kW/m²K. The thickness of outer cover layer 7 therefore lies between 4 and 18 mm.

In this case, the loss of stability is compensated for by load bearing element 8, which extends axially over the whole of drying cylinder 4. The steam in the cavities has a pressure of between 1.5 and 10 bar and flows axially through cavities 12. The supply and disposal of the steam is carried out by way of rotary connections on drying cylinder 4.

On outer cover layer 7, condensation occurs. In order nevertheless to be able to ensure a good transfer of heat from the steam to outer cover layer 7, the inside of cover layer 7 has ribs 10 which project out of the condensate layer.

In FIG. 1, load bearing element 8 is constructed as a thick-walled cylinder shell which, at the same time, bounds cavities 12. Between load bearing element 8 and outer cover layer 7 there are tie rods 9 arranged and distributed over the circumference, which hold outer cover layer 7 to load bearing element 8 counter to the positive pressure of the steam in cavities 12.

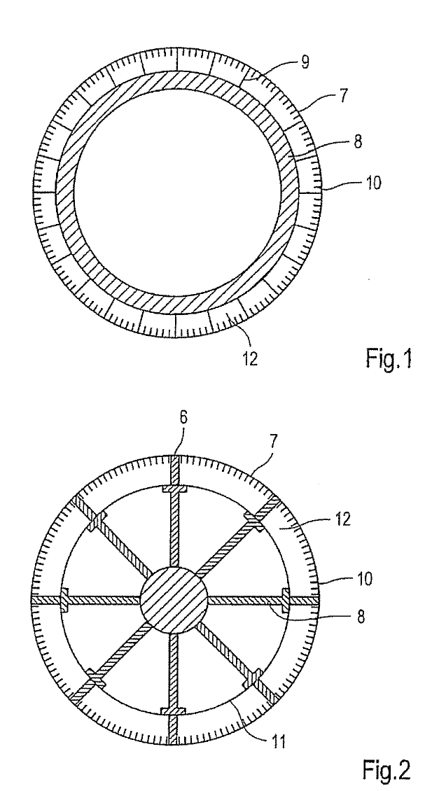

In another embodiment of the present invention, the cavities 12 in FIG. 2 are bounded by an inner cover layer 11 and an outer cover layer 7. Side walls are used as stabilizing connecting elements 6 between these cover layers 7 and 11. Inner cover layer 11 is carried by load bearing element 8.

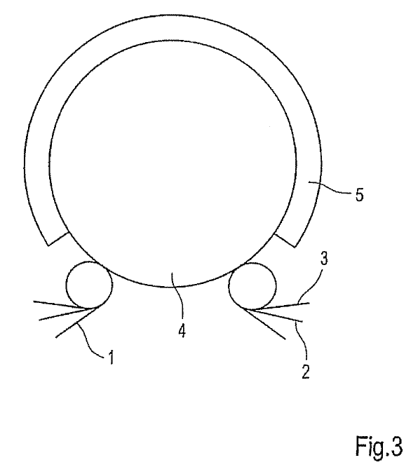

FIG. 3 shows a preferred application of drying cylinder 4 in a drying arrangement in which fibrous web 1 wraps around drying cylinder 4 together with at least one water-absorbing belt 2 and a belt 3 which is dense with respect to the outside. Dense belt 3 wraps around, belt 2, with dense belt 3 being cooled with water from a hood 5.

The heating of fibrous web 1 during the contact with outer cover layer 7 of drying cylinder 4 leads to evaporation and condensation of the liquid in water-absorbing belt 2. This is further assisted by the temperature gradient between drying cylinder 4 and cooled belt 3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drying cylinder for drying one of paper, paperboard, tissue and a fibrous web in a papermaking machine for at least one of producing and finishing the same, the drying cylinder comprising:
a load bearing element; and
an outer cover layer heated by a hot fluid, between said load bearing element and said outer cover layer there is at least one cavity through which the hot fluid flows, at least a portion of said outer cover layer being so thin that a ratio of the thermal conductivity of the material and a thickness of said outer cover layer is greater than a limiting value, which is 3.2 kW/m²K for steel, 30 kW/m²K for aluminum, 18 kW/m²K for bronze alloys, 3.4 kW/m²K for copper and 6.1 kW/m²K for magnesium.

2. The drying cylinder of claim 1, further comprising tie rods, said outer cover layer being supported on said load bearing element by way of said tie rods.

3. The drying cylinder of claim 1, further comprising:
an inner cover layer carried by said load bearing element; and
a plurality of connecting elements, said inner cover layer being connected to said outer cover layer by way of said connecting elements, said at least one cavity being between said inner cover layer and said outer cover layer.

4. The drying cylinder of claim 3, wherein said connecting elements include at least one of webs and slats.

5. The drying cylinder of claim 1, wherein the hot fluid is steam, a pressure in said at least one cavity being between 1.5 and 13 bar.

6. The drying cylinder of claim 1, wherein said outer cover layer has an inner surface that is profiled.

7. The drying cylinder of claim 6, wherein said inner surface is grooved.

8. The drying cylinder of claim 2, wherein said ratio apart from said tie rods is above said limiting value.

9. The drying cylinder of claim 3, wherein said ratio apart from said connecting elements is above said limiting value.

10. The drying cylinder of claim 1, wherein said portion of said outer cover layer is at least 60% of the entire circumferential surface of said outer cover layer having said ratio that is at least on average greater than said limiting value.

11. The drying cylinder of claim 10, wherein said portion of said outer cover layer is at least 75% of the entire circumferential surface of said outer cover layer having said ratio that is at least on average greater than said limiting value.

12. The drying cylinder of claim 1, wherein said drying cylinder is in contact with a portion of the fibrous web with at least one water-absorbent belt thereover and a dense belt overlying said at least one water-absorbent belt, at least a portion of said dense belt being cooled.

13. The drying cylinder of claim 1, wherein said drying cylinder is in contact with a portion of the fibrous web with a belt thereover, the fibrous web being in contact with said drying cylinder, said belt having a tension of at least 10 kN/m.

14. The drying cylinder of claim 13, wherein said tension is at least 20 kN/m.

15. The drying cylinder of claim 13, wherein said belt is a dryer fabric.

16. A papermaking machine producing a fibrous web, the papermaking machine comprising:
a drying cylinder including:
a load bearing element; and
an outer cover layer heated by a hot fluid, between said load bearing element and said outer cover layer there is at least one cavity through which the hot fluid flows, at least a portion of said outer cover layer being so thin that a ratio of the thermal conductivity of the material and a thickness of said outer cover layer is greater than a limiting value, which is 3.2 kW/m²K for steel, 30 kW/m²K for aluminum, 18 kW/m²K for bronze alloys, 3.4 kW/m²K for copper and 6.1 kW/m²K for magnesium;
at least one water-absorbent belt, said water-absorbent belt along with the fibrous web wrapping about a portion of said drying cylinder, the fibrous web being in contact with said drying cylinder; and
a dense belt overlying said at least one water-absorbent belt about said portion of said drying cylinder, at least one portion of said dense belt being cooled.

17. A papermaking machine producing a fibrous web, the papermaking machine comprising:
a drying cylinder including:
a load bearing element; and
an outer cover layer heated by a hot fluid, between said load bearing element and said outer cover layer there is at least one cavity through which the hot fluid flows, at least a portion of said outer cover layer being so thin that a ratio of the thermal conductivity of the material and a thickness of said outer cover layer is greater than a limiting value, which is 3.2 kW/m²K for steel, 30 kW/m²K for aluminum, 18 kW/m²K for bronze alloys, 3.4 kW/m²K for copper and 6.1 kW/m²K for magnesium; and
a belt along with the fibrous web wrapping about a portion of said drying cylinder, the fibrous web being in contact with said drying cylinder, said belt having a tension of at least 10 kN/m.

18. The papermaking machine of claim 17, wherein said tension is at least 20 kN/m.

19. The papermaking machine of claim 17, wherein said belt is a dryer fabric.
